(19) United States
(12) Patent Application Publication
(10) Pub. No.: US 2013/0097476 A1
(43) Pub. Date: Apr. 18, 2013

(54) CONTENT VIEWING APPARATUS, CONTENT DISTRIBUTION SERVER, OPERATION METHOD AND PROGRAM FOR CONTENT VIEWING APPARATUS

(71) Applicant: Shinya KURODA, Tokyo (JP)

(72) Inventor: Shinya KURODA, Tokyo (JP)

(73) Assignee: DWANGO CO., LTD., Tokyo (JP)

(21) Appl. No.: 13/652,806

(22) Filed: Oct. 16, 2012

(30) Foreign Application Priority Data
Oct. 18, 2011 (JP) 2011-229275

(51) Int. Cl. G06F 17/00

(52) U.S. Cl. 715/201

(57) ABSTRACT

In the conventional technologies, although the placed comment is displayed according to time or position of the comment placement, the display cannot be executed by varying display form. For example, an entire comment placed for an entire scene of image content or for an entire page of electronic book content, and a partial comment placed for an object in the scene of the image content or a specific character string in the page of the electronic book content are similarly displayed without varying the display form. In order to solve the problems, we provide a content viewing apparatus, where it is determined that a comment placed for content is the entire comment or the partial comment, and if it is the entire comment, the comment is displayed by moving display, and if it is the partial comment, the comment is fixedly displayed in a predetermined area within the display.

### BACKGROUND OF THE INVENTION

1. Field of the Invention

The present invention relates to a technology for displaying content with comment on a display.

2. Description of the Related Art

Conventionally, a technology for displaying a comment, posted by a user for a movie distributed via the network, on other user's terminals for reproducing the movie simultaneously with the posting has been provided for sharing the experience of viewing the movie with the other users and for communication.

Specifically, in Japanese Unexamined Patent Application Publication No. 2008-172745, movie reproduction time at the point of placing a comment for a movie is managed as comment placing time, and when the movie reproduction time reaches to the comment placing time, content of the comment is displayed by moving display with the movie.

Moreover, as to a text content such as a book, not the movie, a technology for displaying a comment/note placed by a user or a writer to a predetermined character string in the text content by another user's terminal for reproducing the text according to the placing position of the comment.

Specifically, in Japanese Unexamined Patent Application Publication No. 2010-522935, as to a comment (note) etc. placed to a predetermined character string in the text content, for example, the note is displayed in a note display field provided in the right side of a display screen upon displaying the text content including the predetermined character string.

### RELATED ART DOCUMENTS

Patent Document 1: Japanese Unexamined Patent Application Publication No. 2008-172745

Patent Document 2: Japanese Unexamined Patent Application Publication No. 2010-522935

In the above conventional technologies, although the placed comment is displayed according to the comment placing time or the comment placing position, the display cannot be carried out by varying display forms.

For example, an entire comment placed by a user for an entire scene of image content or for an entire page of electronic book content, and a partial comment placed by the user for an object in the scene of the image content or for a specific character string in the page of the electronic book content are similarly displayed without varying the display forms.

### SUMMARY OF THE INVENTION

In order to solve the above deficiencies, we provide a content viewing apparatus, where it is determined that a comment placed for content is the entire comment or the partial comment, and if it is the entire comment, the comment is displayed by moving display, and if it is the partial comment, the comment is fixedly displayed in a predetermined area within the display.

Specifically, an aspect of the invention provides a content viewing apparatus, comprising a display; a content acquisition unit, acquiring a content that can be correlated with an entire comment placed to a basic display unit for displaying the content on the display, and with a partial comment placed to a portion within the basic display unit for displaying the content on the display; a comment acquisition unit, acquiring the comment; an output unit, outputting the acquired content, to which the comment correlated with the content is added, to the display; a determination unit, determining whether the content, outputted from the output unit and to be displayed on the display, has been correlated with the entire comment or the partial comment; an entire comment display controller, when the determination result by the determination unit indicates that the entire comment is correlated, controlling the output unit to display the correlated entire comment by moving display within the display; and a partial comment display controller, when the determination result by the determination unit indicates that the partial comment is correlated, controlling the output unit to fixedly display the correlated comment in a predetermined area within the display.

Moreover, in another aspect of the invention provides a content viewing apparatus, wherein the comment acquisition unit acquires the entire comment to be displayed by the moving display, the entire comment is correlated with a portion in the basic display unit in the content.

Moreover, in addition to the above configuration, in another aspect of the invention provides the content viewing apparatus, further comprising a scaling display controller, controlling to display the basic display unit of the content on the display by enlarging and/or reducing, wherein the entire comment display controller controls the moving display of the entire comment in the content displayed by the enlarging and/or reducing on a basis of the portion in the basic display unit of the content correlated with the acquired entire comment

Moreover, in addition to the above configuration, in another aspect of the invention provides the content viewing apparatus, wherein the entire comment display controller determines one or more of a duration of the moving display, a speed of the moving display of the entire comment to be displayed, a position of the entire comment in the basic display unit of the content, and a character size of the comment.

Moreover, a comment distribution server distributing the entire comment or the partial comment for the above content viewing apparatus is also provided.

Specifically, in another aspect of the invention provides a comment distribution server, distributing a comment correlated with a content that can be correlated with an entire comment placed to a basic display unit for displaying the content on a display of a terminal apparatus, and with a partial comment placed to a portion within the basic display unit for displaying the content on the display of the terminal apparatus, the server comprising an entire comment distribution unit, when the entire comment is correlated with the content displayed on the display of the terminal apparatus, distributing the entire comment displayed by moving display within the display; and a partial comment distribution unit, when the partial comment is correlated with the content displayed on the display of the terminal apparatus, distributing the partial comment fixedly displayed in a predetermined area within the display.

Moreover, a method for operating the content viewing apparatus and a program for the content viewing apparatus are also provided.

According to the present invention having the above configuration, it is determined that a comment placed for content is the entire comment or the partial comment, and the comments are displayed by varying the display forms. For example, the entire comment is displayed by moving display, and the partial comment is fixedly displayed in a predetermined area within the display.

### BRIEF DESCRIPTION OF THE DRAWINGS

FIG. 1 is a conceptual diagram for exemplifying content display and comment display in a content viewing apparatus of a first embodiment.

FIG. 2 is a functional block diagram of the content viewing apparatus of the first embodiment.

FIG. 3 is a diagram for exemplifying management data of an entire comment or a partial comment of the content viewing apparatus of the first embodiment.

FIG. 4 is a diagram for exemplifying hardware configuration of the content viewing apparatus of the first embodiment.

FIG. 5 is a flowchart of the content viewing apparatus of the first embodiment.

FIG. 6 is a functional block diagram of a comment distribution server for distributing the comment to the content viewing apparatus of the first embodiment.

FIG. 7 is a diagram for exemplifying management data of the distributed comment stored in the comment distribution server for distributing the comment to the content viewing apparatus of the first embodiment.

FIG. 8 is a functional block diagram of a content viewing apparatus of a second embodiment.

FIG. 9 is a diagram for exemplifying management data of an entire comment or a partial comment of the content viewing apparatus of the second embodiment.

FIG. 10 is a diagram for exemplifying a determination as to existence of the entire comment display when enlarging/reducing a basic display unit in the content viewing apparatus of the second embodiment.

FIG. 11 is a flowchart of the content viewing apparatus of the second embodiment.

FIG. 12 is a functional block diagram of a content viewing apparatus of a third embodiment.

FIG. 13 is a diagram for exemplifying display of an entire comment or a partial comment of the content viewing apparatus of the third embodiment.

FIG. 14 is a flowchart of the content viewing apparatus of the third embodiment.

### DESCRIPTION OF THE PREFERRED EMBODIMENTS

Hereinafter, embodiments of the present invention will be described with reference to diagrams. The present invention is not to be limited to the above embodiments and able to be embodied in various forms without departing from the scope thereof.

The first embodiment will mainly describe Claims 1, 5, 6 and 7. The second embodiment will mainly describe Claims 2 and 3. The third embodiment will mainly describe Claim 4.

### First Embodiment

### Outline of First Embodiment

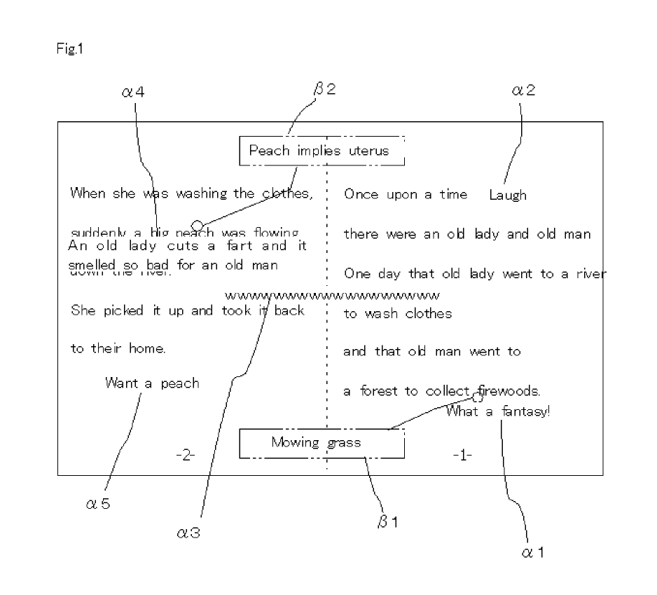

FIG. 1 is a conceptual diagram for exemplifying content display and comment display placed to the content in a content viewing apparatus of a first embodiment. As shown in FIG. 1, for example, two page-spread of an electronic book content is displayed, and the entire comments α1 to α5 are displayed on the content moving from right to left. Meanwhile, the comments placed to the character string ‘mowing grass’ and ‘washing clothes’ are fixedly displayed in the predetermined areas β1 and β2.

According to the content viewing apparatus of the first embodiment, the entire comment is displayed by moving display, and the partial comment is fixedly displayed in the predetermined area within the display.

<Functional Configuration of First Embodiment>

Note that, the functional block of the apparatus can be implemented by hardware, software, or both hardware and software. Specifically, in the case of using a computer, the respective units are implemented by the hardware configured by a CPU, a main memory, a bus, a secondary storage device (e.g., a hard disk or a nonvolatile memory, a storage media such as CD or DVD, or a reading drive for the above media), input device for inputting information, display device, printing device, other peripheral devices, and interface for the other peripheral devices and communication interface; and driver program for controlling the above hardware, other application programs, and application for user interface.

Subsequently, the CPU executes operation in accordance with the program loaded into the main memory, so that processing, storing and outputting of the data, inputted through the input device or the interface etc. and stored in the memory of the hard disk, are carried out, and instructions to control the hardware and software are generated. Moreover, the present invention can be implemented not only as an apparatus but also as a method thereof. Moreover, a portion of such inventions may be configured as software. Furthermore, a software product used for causing a computer to execute the software, and the recording medium, in which the software is installed, should be included in the technical scope of the present invention (the same applies throughout the entire specification).

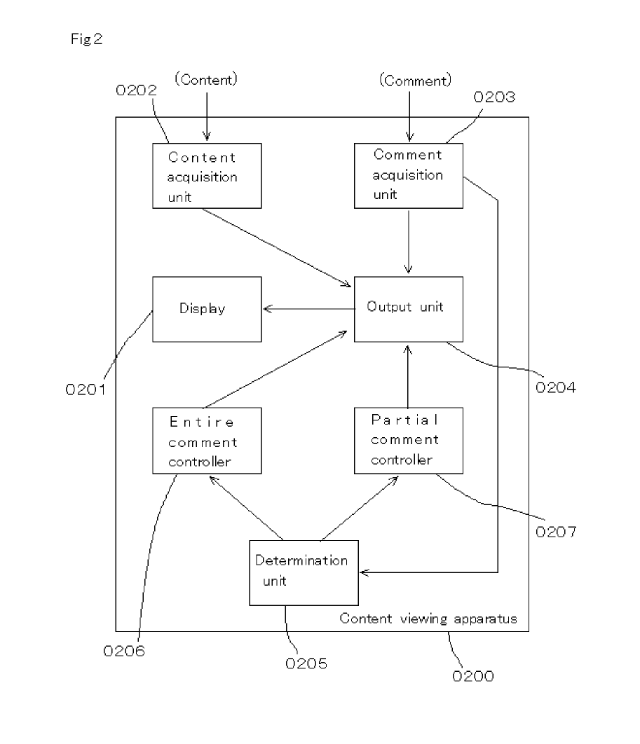

As shown in FIG. 2, a ‘content viewing apparatus’ of the first embodiment (0200) comprises a ‘display’ (0201), a ‘content acquisition unit’ (0202), a ‘comment acquisition unit’ (0203), an ‘output unit’ (0204), a ‘determination unit’ (0205), an ‘entire comment display controller’ (0206), and a ‘partial comment display controller’ (0207).

The ‘display’ (0201) has a function of displaying the acquired content or comment. The display form is not limited, and examples of the display include a liquid-crystal display, a plasma display, and an organic EL display.

The ‘content acquisition unit’ (0202) has a function of acquiring a content that can be correlated with an entire comment and with a partial comment, and can be implemented by a CPU, a main memory, and a content acquisition program.

Note that the acquisition source of the content acquired by the content acquisition unit is not limited. For example, the content may be acquired from the content distribution server on the web via the internet, or may be acquired by loading the content stored in the internal HDD in the content viewing apparatus or by loading the content recorded in a recording medium such as an optical disk.

Moreover, the entire comment and the partial comment may be correlated with the content, and the content viewing apparatus of the first embodiment displays the entire comment and the partial comment by varying the display form.

The ‘entire comment’ is a comment placed for the basic display unit in displaying the content on the display. The ‘basic display unit’ is a display unit, displayed in default setting without scaling, such as a page or two-page spread of the electronic book content, or an image of image content. Note that the display of the basic display unit depends on setting, and may be displayed as a portion of a page of a normal book (e.g., a frame of an electronic comic content)

The ‘partial comment’ is a comment placed for a portion of the basic display unit in displaying the content on the display, and examples thereof include a comment placed for a predetermined character or character string in the text content of the electronic book, and a comment placed for a predetermined position (coordinate x, y) as a portion of the basic display unit of the image content.

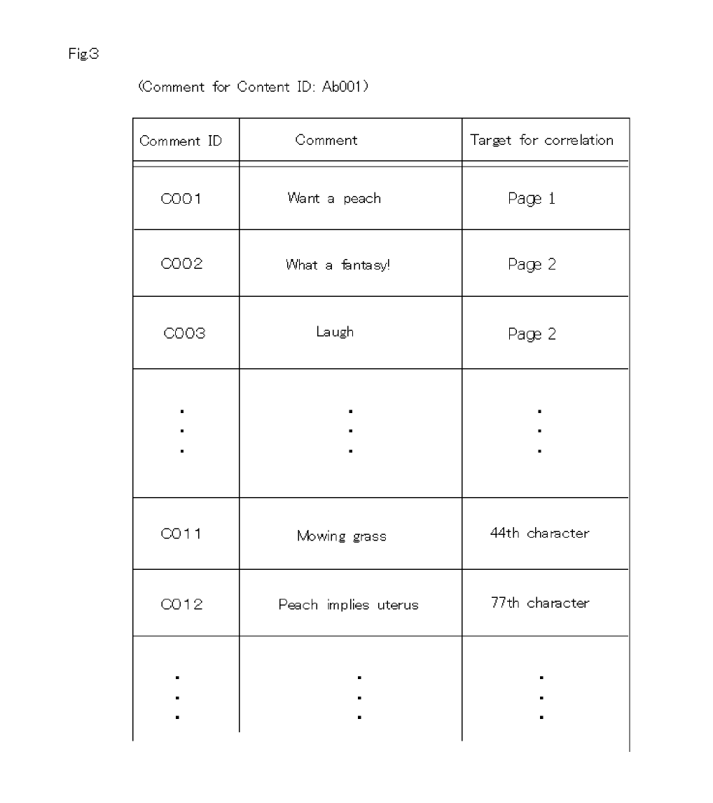

FIG. 3 is a diagram for exemplifying management data of an entire comment or a partial comment of the content viewing apparatus of the first embodiment. As shown in FIG. 3, the entire comment is managed by being correlated with identification information (ID) of the basic display unit such as the first or second page when a page is set as the basic display unit. Meanwhile, the partial comment is managed by being correlated with identification information of a portion of the basic display unit such as 44th character from the head of the page (or n-th character from the head of the second page), or coordinate (100, 75) in the first page. Moreover, the correlation of the partial comment may be carried out by word unit such as ‘a fun’ from 44th to 47th character. Moreover, the text data may be managed by word (character string) unit, thereby specifying the correlated portion by the number of words such as 10th word, not by the number of characters.

When the partial comment is correlated by word unit, the correlation may be carried out, such that the partial comment can be referred to by the same/synonymous word in the other page of the content.

By utilizing the above management data, the content viewing apparatus of the first embodiment can distinguish the entire or partial comment, and can determine where the comment is displayed for the content.

Note that the above configuration is just an example, and as described in a second embodiment, the management data, where the entire comment is correlated for convenience with a portion in the basic display unit in the content similar to the partial comment, and the comments are distinguished by flag information etc, may be used. Moreover, not the table data, a configuration, where the information indicating the target for correlation is included in the respective comment information as a header or other additional information, may be used.

Moreover, the correlation between the basic display unit of the content or the portion thereof and the comment may be carried out in various forms. For example, in the content viewing apparatus of the first embodiment, a field for the comment is provided in the display screen of the content, and when the comment is placed and a transmission button is pressed, the identification information of the basic display unit of the displayed content is acquired as the target for correlation. Moreover, when the comment is placed in the similar field, and a desired position in the displayed content is designated by a mouse pointer etc, and the transmission button is pressed, the coordinate information of the designated position may be acquired as the identification information of the portion as the target for correlation. Moreover, it is possible to separately accept the operation input of a command button to distinguish that the comment is the entire comment or the partial comment. Then, the correlated comment and the identification information of the basic display unit or the portion thereof are transmitted to the comment distribution server, thereby generating the management table data as shown in FIG. 3, or adding the identification information of the target for correlation to the comment.

Moreover, the entire comment and the partial comment may be placed by a viewer of the content, or by a writer or a distributor of the content as a note. In such case, the entire comment and the partial comment placed by the writer may be preliminarily placed to the content.

The ‘comment acquisition unit’ (0203) has a function of acquiring the entire comment and/or the partial comment, and can be implemented by a CPU, a main memory, and a comment acquisition program. Note that the acquisition source of the comment acquired by the comment acquisition unit is not limited. For example, the comment may be acquired from the comment distribution server on the web via the internet, or may be acquired by loading the comment correlated with content stored in the internal HDD in the content viewing apparatus or by loading the comment correlated with content recorded in a recording medium such as an optical disk.

Moreover, the content and the comment may be acquired from the same source or from different sources. For example, the content and the comment may be acquired from the content distribution server and the comment distribution server (or a distribution server integrally configured by both servers) via the internet, or the content may be acquired from the internal HDD, and the comment may be acquired from the comment distribution server by a request via the internet using a content ID as a key.

Note that a configuration of the comment distribution server for distributing the entire or partial comment correlated with the content via the communication network such as the internet will be described.

The ‘output unit’ (0204) has a function of outputting the acquired content, to which the comment correlated with the content is added, to the display, and can be implemented by a CPU, a main memory, a calculation unit or a VRAM for image processing and a comment acquisition program.

Moreover, the content viewing apparatus of the first embodiment is provided with the following configuration to display the entire or partial comment on the display by different forms in outputting from the output unit.

The ‘determination unit’ (0205) has a function of determining whether the content, outputted from the output unit and to be displayed on the display, has been correlated with the entire comment or the partial comment, and can be implemented by a CPU, a main memory, and a determination program.

Specifically, for example, the management table data of FIG. 3 is acquired with the content, and the management table data is referred by using the identification information (e.g., page number) of the basic display unit or the identification information (e.g., character number) of the portion of the content to be outputted, thereby determining whether the comment is correlated. Moreover, when the ID of the basic display unit or the ID of the portion of the correlation target is included in the each acquired comment as the additional information, the additional information is referred, thereby carrying out the determination.

Moreover, when the additional information is included with respect to each basic display unit of the content, and the additional information indicates the ID of the comment correlated with the basic display unit, the additional information included with respect to each basic display unit of the content is referred, thereby carrying out the determination. Moreover, depending on that the target for the correlation is the identification information of the basic display unit or the identification information of the portion, it is determined that the entire comment or the partial comment. When the flag information for distinguishing the entire comment or the partial comment is added to the comment, the flag information is referred, thereby determining that the entire comment or the partial comment.

The ‘entire comment display controller’ (0206) has a function of controlling the output unit to display the correlated entire comment by moving display within the display when the determination result by the determination unit indicates that the entire comment is correlated, and can be implemented by a CPU, a main memory, and an entire comment display control program.

The ‘entire comment’ by moving display’ means that when the basic display unit of the content as the correlation target is displayed on the display, the entire comment is displayed by moving within the display according to the content display. The moving form, moving speed, and moving start position are not limited. For example, the comment is displayed by overlapping and moving over the displayed content from right to left in the display. Moreover, when simultaneously displaying a plurality of comments, as after mentioned in the third embodiment, the positions and display start timing of the respective comments may be varied.

The ‘partial comment display controller’ (0207) has a function of controlling the output unit to fixedly display the correlated comment in a predetermined area within the display when the determination result by the determination unit indicates that the partial comment is correlated, and can be implemented by a CPU, a main memory, and a partial comment display control program.

The ‘fixed display of partial comment’ means that when the basic display unit of the content as the correlation target is displayed on the display, the partial comment is displayed at approximately fixed position in a predetermined area within the display according to the content. The fixed position and a size of the predetermined area are not limited. For example, an area partially overlapping with the display field of the content is displayed as the fixed display area. Moreover, when simultaneously displaying a plurality of comments, comments may be displayed one by one in the predetermined area.

Moreover, in the first embodiment, the partial comment is fixedly displayed in the predetermined area, and the position of the predetermined area may be appropriately varied. For example, it is determined by using the coordinate information whether the portion of the content (e.g. predetermined character string), to which the partial comment is placed, overlaps with the predetermined area, and when there is an overlap, the position of the predetermined area is moved to the position without overlap. Thus, it is possible to prevent the overlap between the partial comment is displayed at approximately fixed position in a predetermined area and the portion as the target for the comment.

According to the present invention having the above configuration, it is determined that a comment placed for content is the entire comment or the partial comment, and the comments are displayed by varying the display form. For example, the entire comment is displayed by moving display, and the partial comment is fixedly displayed in a predetermined area within the display.

### Hardware Configuration of First Embodiment

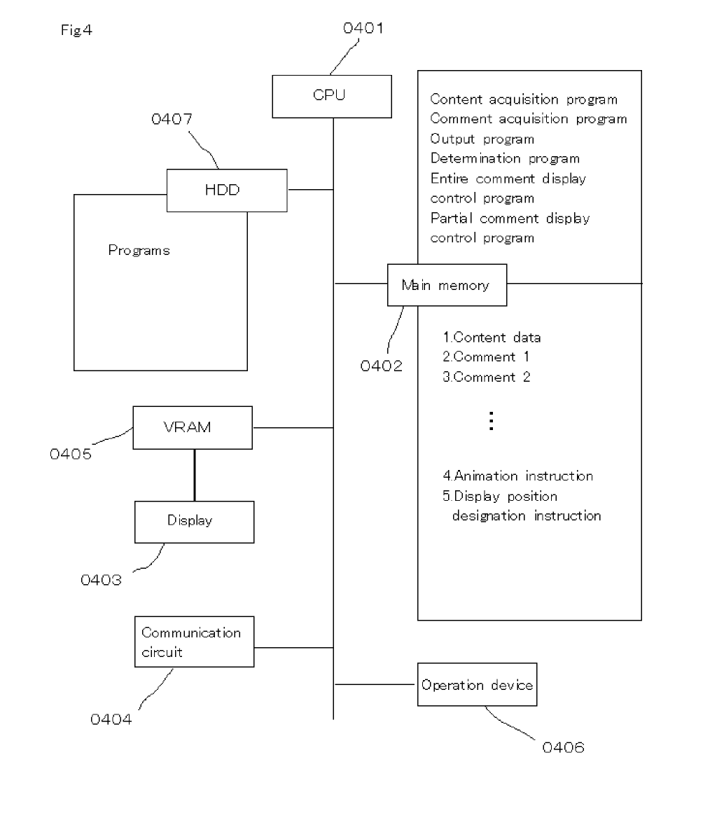

FIG. 4 is a diagram exemplifying a hardware configuration for implementing the above respective components in the content viewing apparatus. Hereinafter, descriptions of operations of the respective hardware components in the display processing of the content, the entire comment and the partial comment will be provided with reference to FIG. 4.

As shown in FIG. 4, the content viewing apparatus is provided with a ‘CPU (Central Processing Unit)’ (0401), and a ‘main memory’ (0402). The ‘CPU’ and the ‘main memory’ calculate for executing the various processes, and implement the respective components such as the determination unit, the entire comment display controller, and the partial comment display controller.

Moreover, the content viewing apparatus is provided with a ‘display’ (0403), a ‘communication circuit’ (0404) as the content acquisition unit and the comment acquisition unit, a ‘VRAM’ (0405) as the output unit, an ‘operation device’ (0406), and an ‘HDD’ (0407).

Moreover, the programs are loaded into the ‘main memory’, and the ‘CPU’ refers to the program and executes the various calculations. Moreover, a plurality of addresses are assigned to the ‘main memory’ and the ‘HDD’, and in the calculation by the ‘CPU’, address specification and access to the stored data are carried out, thereby executing the calculation by utilizing the data.

Subsequently, when receiving the operation input from the user via the ‘operation device’, the ‘CPU’ interprets the content acquisition program, and according to the result, accesses to the content distribution server, thereby transmitting a content distribution request (HTTP request) via the ‘communication circuit’. Moreover, the ‘CPU’ also interprets the comment acquisition program, thereby transmitting a comment distribution request including the content ID of the request target via the ‘communication circuit’. As described above, the acquisition source of the content and the comment are not limited to the server on the web, and it is possible to acquire them from the internal ‘HDD’ in response to the user's operation input. Subsequently, in response to the requests, the content and the comment, distributed from the respective servers and the management data table of FIG. 3 are received via the ‘communication circuit’, and stored in the ‘main memory’ and the ‘HDD’.

Subsequently, the ‘CPU’ interprets the output program, and loads the content data into the work area in the ‘main memory’ in order to execute processing for outputting the basic display unit of the acquired content such as enlargement processing when the page to be displayed is compressed data. Subsequently, when there is no scaling display, the ‘CPU’ interprets the determination program, and acquire the identification information of the loaded basic display unit, for example, from the header information of the loaded content data. Subsequently, searching the management data table of FIG. 3, which has been acquired by calculation by the ‘CPU’ is executed by using the identification information as a key.

When the comment ID correlated with the basic display unit exists, for example, by distinguishing whether the correlation target is the basic display unit, or by referring the flag information added to the comment, the ‘CPU’ determines that the comment is the entire comment or the partial comment.

Moreover, when the total number of the entire comments and the partial comments is more than or equal to a predetermined number, or when the number of the entire comments or the partial comments is more than or equal to a predetermined number, only the selected number of comments may be displayed. For example, with the determination, the number of comments is counted, and stored at a predetermined address in the ‘main memory’. Subsequently, a threshold value preliminarily determined by the determination program and the counted number are compared by the calculation by the ‘CPU’, and when the counted number is smaller than the threshold value, all the specified comments are displayed. When the counted number is larger than the threshold value, selection of comments within the threshold value is executed according to the predetermined rule by the determination program. For example, as the predetermined rule, a rule to select comments in ascending/descending time order of comment placing time with reference to the comment placing time data indicated by the additional information of the comment, or a rule to randomly select is applicable. Moreover, when a valuation cumulative total value etc. given by other users is correlated with the comment and managed, a rule to select comments in a priority order based on the value.

Moreover, the threshold value indicating the predetermined number may be variable. For example, information indicating resolution of the display area of the content or the display screen, or the character size of the comment, or information indicating tolerance for overlap between the comments is acquired, and on the basis of the information, the number of comments, simultaneously displayable within a screen or a display area, is calculated using a predetermined formula f(x) etc.

As the result, the comment determined to be the entire comment is loaded into the ‘main memory’, and an animation instruction for moving display on the ‘display’ is generated by processing by the ‘CPU’ according to the entire comment display control program. The comment determined to be the partial comment is loaded into the ‘main memory’, and a display position designation instruction to fixedly display the comment in the predetermined area on the ‘display’ is generated by processing by the ‘CPU’ according to the partial comment display control program.

Subsequently, as to the content preliminarily loaded into the ‘main memory’ by the ‘CPU’, enlargement processing is executed as necessary, and the content is loaded on the ‘VRAM’, and is sequentially loaded on the ‘VRAM’, such that the entire comment is displayed in animation according to the animation instruction, and the partial comment is loaded at the predetermined position on the ‘VRAM’.

Therefore, the content is displayed on the ‘display’, and the entire comment is displayed by moving display, and the partial comment is fixedly displayed in the predetermined area.

### Processing Flow of First Embodiment

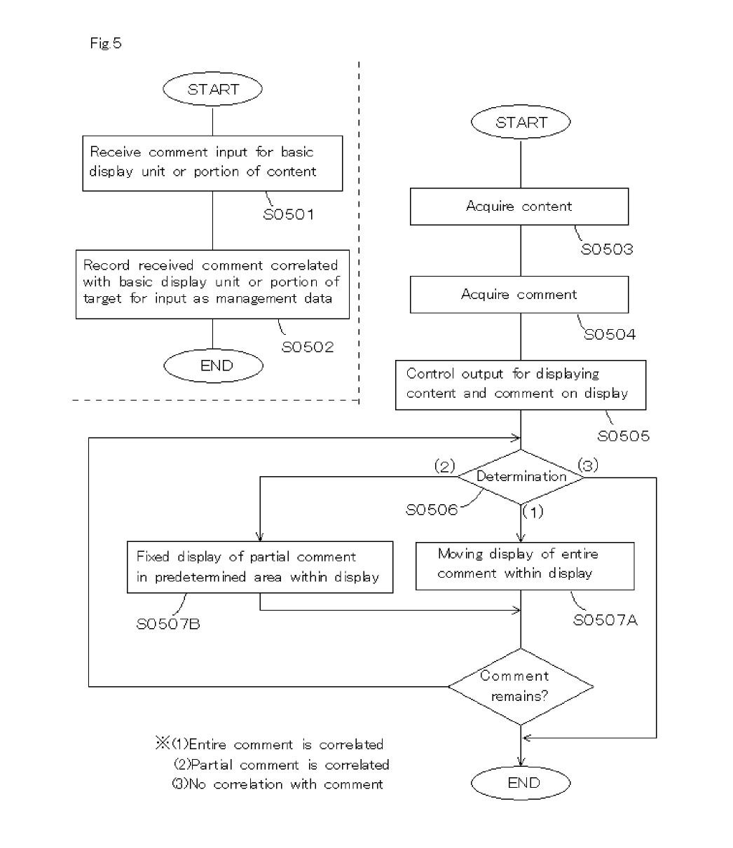

FIG. 5 is a flowchart of the content viewing apparatus of the first embodiment. Note that, the following step may be executed by the respective hardware configurations of a computer as above, or may configure a program, which is stored in a medium and is for controlling the computer. Moreover, although the following steps are described in an example where the content and comment are acquired from the server on the web, as described above, the acquisition source is not limited to the example.

As shown in FIG. 5, at the outset, on the basis of the determination as to the entire comment or the partial comment, when the content viewing apparatus receives an input of a comment for the basic display unit or the portion thereof (step S0501), a correlation between the comment and the basic display unit or the portion thereof are made, and the correlation information is stored in the comment distribution server etc. as the management data (step S0502).

Subsequently, in response to the content distribution request from the content viewing apparatus, the content is acquired from the server on the web etc. (step S0503). Moreover, the entire comment and the partial comment correlated with the content are acquired (step S0504). Note that the acquisition may be executed before the acquisition of the content (before the step S0503), may be executed simultaneously with the acquisition, or may be appropriately executed after the acquisition according to the display of the basic display unit of the content.

Subsequently, the comment correlated with the content is added to the acquired content, and output control to display the content and comment on the display is executed (step S0505), and it is determined whether the content, outputted from the output unit and to be displayed on the display, has been correlated with the entire comment or the partial comment (step S0506). Note that when a plurality of comments are placed for the content as the target for the output control, the determination is executed one by one.

When the determination result by the step S0506 indicates that the entire comment is correlated, the correlated entire comment is displayed by moving display within the display (step S0507A). When the determination result by the step S0506 indicates that the partial comment is correlated, the correlated comment is fixedly displayed in a predetermined area within the display (step S0507B).

### Effects of First Embodiment

According to the stage production system of the first embodiment, it is determined that a comment placed for content is the entire comment or the partial comment, and the comments are displayed by varying the display form. For example, the entire comment is displayed by moving display, and the partial comment is fixedly displayed in a predetermined area within the display.

Therefore, the viewer of the content can grasp that the target for the comment is the entire or portion of the content, so that can understand the intention of placing the comment, and can share the experience of viewing the content and enjoy the simulated communication.

### Comment Distribution Server

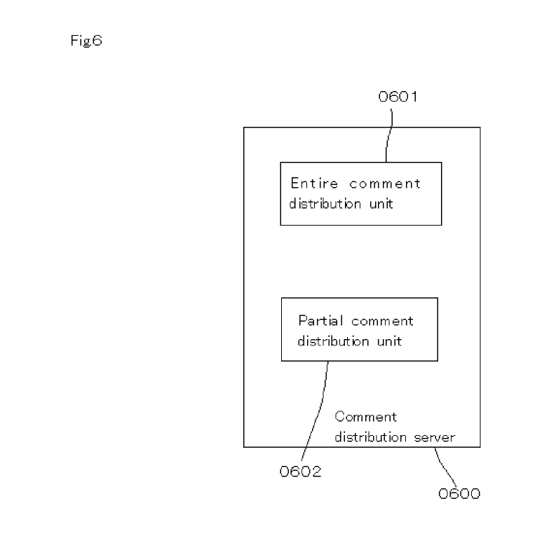

FIG. 6 is a functional block diagram of a comment distribution server for distributing the comment to the content viewing apparatus of the first embodiment. As shown in FIG. 6, a ‘comment distribution server’ of the second embodiment (0600) comprises an ‘entire comment distribution unit’ (0601), and a ‘partial comment distribution unit’ (0602).

The ‘entire comment distribution unit’ (0601) has function of distributing the entire comment displayed by moving display within the display; when the entire comment is correlated with the content displayed on the display of the terminal apparatus, and can be implemented by a CPU, a main memory, and a entire comment distribution program.

The ‘partial comment distribution unit’ (0602) has a function of distributing the partial comment fixedly displayed in a predetermined area within the display, when the partial comment is correlated with the content displayed on the display of the terminal apparatus, and can be implemented by a CPU, a main memory, and a partial comment distribution program.

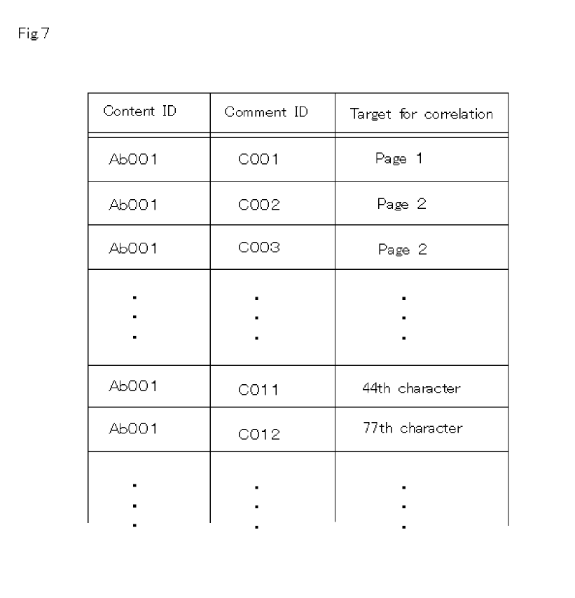

For example, FIG. 7 is a diagram for exemplifying management data table of the distributed comment stored in the comment distribution server. As shown in FIG. 7, the management table, where the ID of the entire comment and/or partial comment and the content ID of the comment are correlated and stored. When an display instruction of displaying the content is inputted in the content viewing apparatus by user's operation, the content ID as the reproduction target is acquired via the communication network such as the internet. Subsequently, the comment distribution server refers the management data table of FIG. 7, and specifies the correlated comment ID by using the acquired content ID as a key. Subsequently, the entire comment and partial comment identified by the specified ID are directly distributed to the content viewing apparatus as the transmission source of the content ID, or indirectly distributed via another server (e.g., content distribution server).

Note that the comment distribution server may distributes the comment after determining that the comment is the entire or partial comment with reference to the additional information of the specified comment, or may distributes the entire and partial comment without such determination.

### Second Embodiment

### Outline of Second Embodiment

A second embodiment is a content viewing apparatus based on the first embodiment, where the entire comment, correlated with the basic display unit of the content, is correlated for convenience with a portion in the basic display unit in the content.

According to such configuration, even when the content is displayed by scaling, not by the basic display unit, it is determined whether the portion correlated for convenience with the entire comment is included within the displayable range of the display, thereby determining whether the entire comment is displayed by moving display.

### Functional Configuration of Second Embodiment

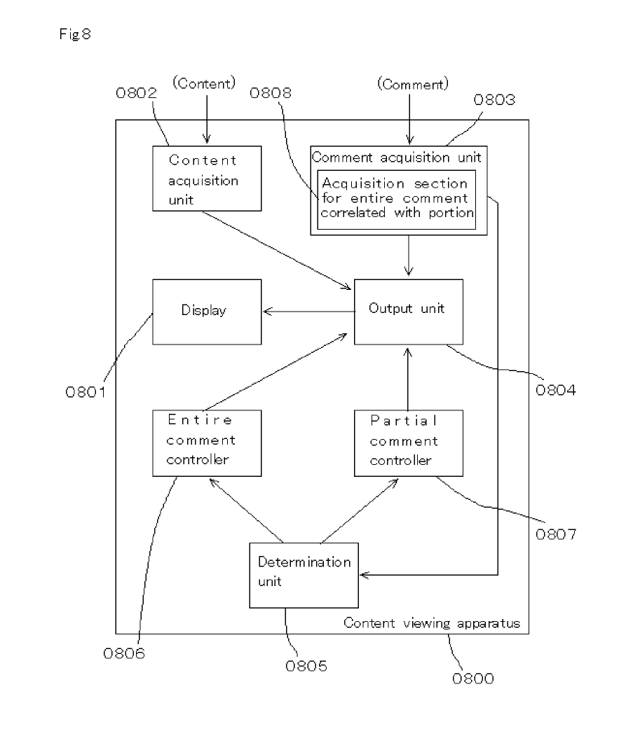

FIG. 8 is a functional block diagram of the content viewing apparatus of the second embodiment. As shown in FIG. 8, a ‘content viewing apparatus’ of the second embodiment (0800) comprises a ‘display’ (0801), a ‘content acquisition unit’ (0802), a ‘comment acquisition unit’ (0803), an ‘output unit’ (0804), a ‘determination unit’ (0805), an ‘entire comment display controller’ (0806), and a ‘partial comment display controller’ (0807). These components have been described in the above embodiment, so that descriptions thereof are omitted.

The ‘content viewing apparatus’ of the second embodiment further comprises an ‘acquisition section for entire comment correlated with portion’ (0808).

The ‘acquisition section for entire comment correlated with portion’ (0808) has a function of acquiring the entire comment to be displayed by the moving display, which is correlated with a portion in the basic display unit in the content.

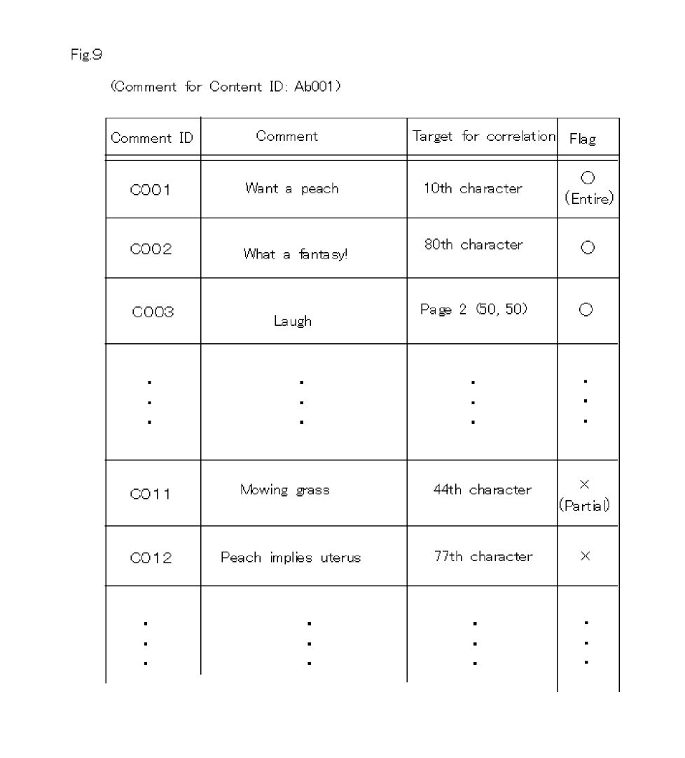

FIG. 9 is a diagram for exemplifying management data table of an entire comment or a partial comment of the content viewing apparatus of the second embodiment. As shown in FIG. 9, the entire comment, correlated with the basic display unit of the content, is correlated for convenience with a portion in the basic display unit in the content, and it is possible to distinguish the comments by using the flag information. As described in the first embodiment, the management can be executed by adding the correlation information or the flag information to each comment, not by the management data table.

Moreover, it is not limited which portion of the basic display unit is correlated with the entire comment. For example, the coordinate information indicating the portion in the basic display unit of the content as the correlation target may be randomly set, or predetermined coordinate information such as a central position of the basic display unit may be set.

According to such configuration, even when the content is displayed by scaling, not by the basic display unit, it is determined whether the portion correlated for convenience with the entire comment is included within the displayable range of the scaling display, thereby determining whether the entire comment is displayed by moving display.

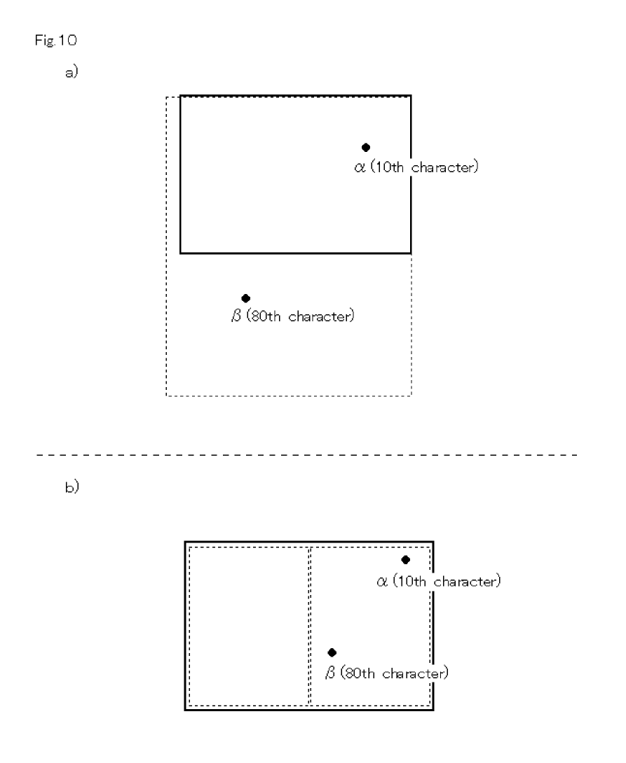

FIG. 10 is a diagram for exemplifying a determination as to existence of the entire comment display when enlarging/reducing a basic display unit in the content viewing apparatus of the second embodiment. As shown in FIG. 10(α), when enlarging the basic display area indicated by perforated line, the portion α of the content is included in the displayable range indicated by the solid line, and the portion β is not included in the displayable area. In this case, the entire comment A correlated with the portion α is displayed by moving display, but the entire comment B correlated with the portion β is not displayed.

Meanwhile, as shown in FIG. 10(a), when enlarging the basic display area indicated by perforated line, the portions α and β of the content are included in the displayable range indicated by the solid line. In this case, the both entire comments A and B are displayed by moving display.

Thus, when a scaling display controller for controlling to display the basic display unit of the content on the display by enlarging and/or reducing is comprised, and the display by enlarging and/or reducing is executed, the entire comment display controller controls the moving display of the entire comment in the content displayed by the enlarging and/or reducing on a basis of the portion in the basic display unit of the content correlated with the acquired entire comment

### Processing Flow of Second Embodiment

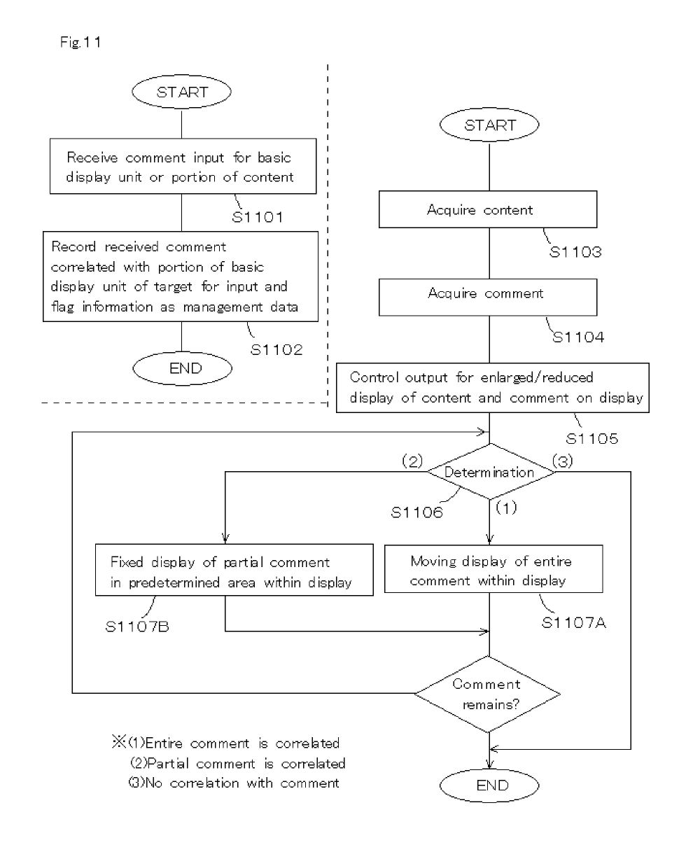

FIG. 11 is a flowchart of the content viewing apparatus of the second embodiment. Note that, the following step may be executed by the respective hardware configurations of a computer as above, or may configure a program, which is stored in a medium and is for controlling the computer.

As shown in FIG. 11, at the outset, on the basis of the determination as to the entire comment or the partial comment, when the content viewing apparatus receives an input of a comment for the basic display unit or the portion thereof (step S1101), a correlation among the comment, the identification information identifying that the basic display unit of the content as the input target, and the flag information etc. for identifying that the comment is the entire comment or the partial comment, is made, and the correlation information is stored in the comment distribution server etc. as the management data (step S1102).

Subsequently, in response to the content distribution request from the content viewing apparatus, the content is acquired from the server on the web etc. (step S1103). Moreover, the entire comment and the partial comment correlated with the content are acquired (step S1104).

Subsequently, the comment correlated with the content is added to the acquired content, and output control to display the content and comment by scaling display on the display is executed (step S1105), and it is determined whether the content, outputted from the output unit and to be displayed on the display, has been correlated with the entire comment or the partial comment by using the identification information of the basic display unit correlated with the comment (step S1106).

When the determination result by the step S1106 indicates that the entire comment is correlated, the correlated entire comment is displayed by moving display within the display (step S1107 A). When the determination result by the step S0506 indicates that the partial comment is correlated, the correlated comment is fixedly displayed in a predetermined area within the display (step S1107 B). When a plurality of comments are correlated, the determination in the step S1106 is executed one by one, and repeated until there is no remaining comments. When no comment is correlated, the display control of the comment is not executed.

### Effects of Second Embodiment

According to the content viewing apparatus of the second embodiment, where the entire comment, correlated with the basic display unit of the content, is correlated for convenience with a portion in the basic display unit in the content.

According to such configuration, even when the content is displayed by scaling, not by the basic display unit, it is determined whether the portion correlated for convenience with the entire comment is included within the displayable range of the display, thereby determining whether the entire comment is displayed by moving display.

### Third Embodiment

### Outline of Third Embodiment

A third embodiment is a content viewing apparatus based on the above embodiment, where a duration of the moving display, a moving position of the entire comment, and a character size of the comment are appropriately controlled. According to this control, for example, it is possible to display a plurality of entire comments without overlap, or the moving comment without overlapping with the partial comment, which is fixedly displayed.

### Functional Configuration of Third Embodiment

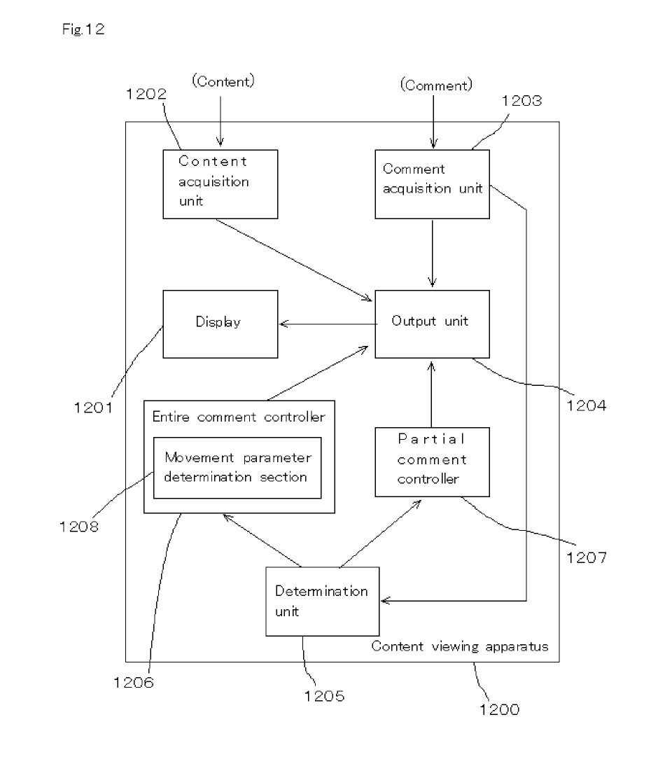

FIG. 12 is a functional block diagram of the content viewing apparatus of the third embodiment. As shown in FIG. 12, a ‘content viewing apparatus’ of the third embodiment (1200) comprises a ‘display’ (1201), a ‘content acquisition unit’ (1202), a ‘comment acquisition unit’ (1203), an ‘output unit’ (1204), a ‘determination unit’ (1205), an ‘entire comment display controller’ (1206), and a ‘partial comment display controller’ (1207). Moreover, on the basis of the second embodiment, the comment acquisition unit may further comprise an ‘acquisition section for entire comment correlated with portion’, which is not indicated in figure. These components have been described in the above embodiment, so that descriptions thereof are omitted.

Moreover, in the content viewing apparatus of the third embodiment, the entire comment display controller further comprises a ‘moving parameter determination section’ (1208).

The ‘moving parameter determination section’ (1208) has a function of determining one or more of a duration of the moving display, a speed of the moving display of the entire comment to be displayed, a position of the entire comment in the basic display unit of the content, and a character size of the comment, and can be implemented by a CPU, a main memory, and a moving parameter determination program.

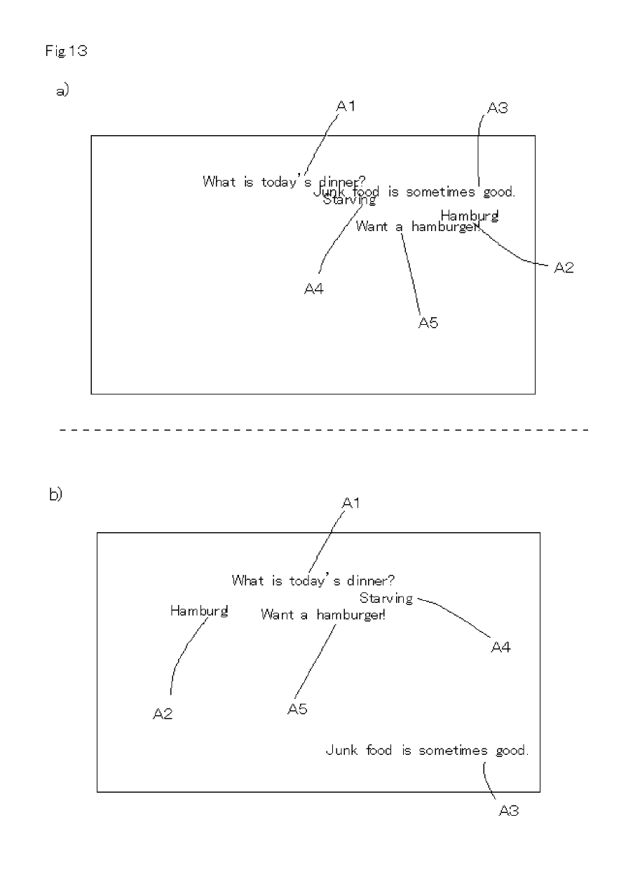

FIG. 13 is a diagram for exemplifying display of an entire comment or a partial comment of the content viewing apparatus of the third embodiment. As shown in FIG. 13(a), as to the entire comments A1 to A5, which are possibly displayed with overlaps, the starting time or moving speed of the moving display is varied as shown in FIG. 13(b) (A2), the starting position or moving route of the moving display is varied (A3), or the character size of the comment (including font and character decoration) is varied (A4).

Specifically, as to the entire comments, on the basis of the initial user designation etc, the tentative moving display parameter such as the starting position, the starting time, and the moving speed, and the character size, is determined. Subsequently, the information of character string length etc. is added, and it is determined by the CPU calculation whether there is overlap between the respective entire comments in the display on the basis of the tentative parameter. When there is an overlap, as to other comments excluding one comment, for example, the processing of varying the starting time, and the moving speed, and the character size is executed in addition to variation of the starting position, and it is repeatedly determined whether there are overlaps among the entire comments displayed on the basis of the tentative parameter. Subsequently, the parameter, where there is an overlap or are overlaps more than or equal to the preset threshold among the entire comments, is finally determined as the final parameter.

Moreover, when varying the display starting position, the display starting time, and the display moving speed, and the character size, the variation may be executed on the basis of a predetermined priority. Examples of this priority includes a priority determined by ascending/descending time order of comment placing time indicated by the additional information of the comment, and a priority determined by the valuation cumulative total value etc. when the valuation cumulative total value etc. given by other users are correlated and managed. In order to prevent from overlap of the comment with high priority, the comment with low priority is displayed by translucent form or small character or displayed at the starting position in lower portion of the screen where the comment is not easily viewed because viewpoint generally moves from upper portion to lower portion of the screen.

Moreover, other than the method for preventing the overlap by varying the display starting position, the display starting time, and the display moving speed, and the character size, it is possible to vary color or color tone of the overlapping comments, such that the overlapping comments are easily viewed.

Moreover, the determination may be executed, not only as to overlaps among the entire comments, but also as to overlap among the entire comment and the partial comment fixedly displayed. In this case, since the display position of the partial comment is fixed, when the comments horizontally move, the determination of overlap can be executed by the coordinates of vertical display positions of both comments and display time of the partial comment. When there is overlap, similar to the processing for the entire comments, it is possible to vary the display starting position, the display moving speed, and the character size, or to vary the color or color tone of the comments.

Moreover, the moving parameter determination section may determine the moving display parameter of the entire comment, such that the entire and partial comments are displayed with overlaps. Specifically, for example, when the position of predetermined area for fixedly displaying the partial comment is variable in order to prevent the overlap, the position of the predetermined area at the point of moving display of the entire comment is acquired. Subsequently, the position moved vertically by the font size of the character string (in the case of vertical moving display, the position moved horizontally) is determined as the starting position of the moving display of the entire comment.

Thus, it is possible to display without overlap among the entire comments or among the entire comment and the partial comment. Therefore, the user can easily understand the respective comments.

### Processing Flow of Third Embodiment

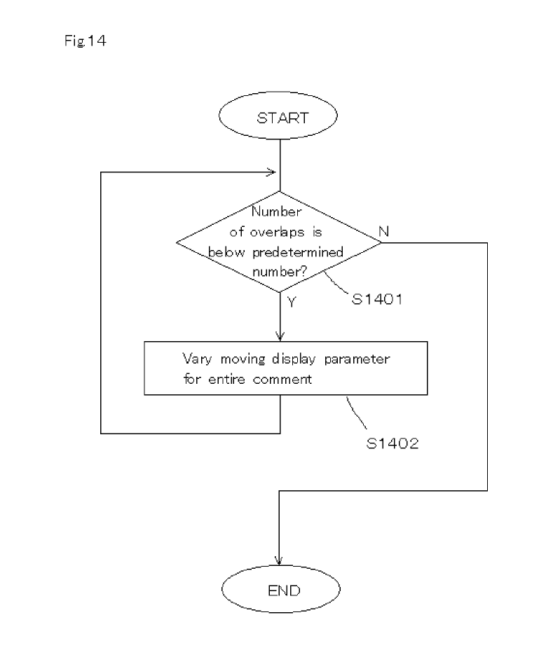

FIG. 14 is a flowchart of the content viewing apparatus of the third embodiment. Note that, the following step may be executed by the respective hardware configurations of a computer as above, or may configure a program, which is stored in a medium and is for controlling the computer. The acquisition of the content and comment, and the determination of correlation between the content and the entire/partial comment are the same as those of FIG. 5 in the first embodiment, so that the descriptions are omitted. Hereinafter, the steps in the display processing of the entire comment (step S0507 A) in FIG. 5 are described.

As shown in FIG. 14, as to the entire and partial comments correlated with the basic display unit of the content or portion thereof, it is determined whether the number of overlaps is less than or equal to a predetermined number (step S1401). Specifically, as to the entire comments, on the basis of the initial user designation etc, the tentative moving display parameter such as the starting position, the starting time, and the moving speed, and the character size, is determined. Subsequently, the information of character string length etc. is added, and as to display based on the tentative moving display parameter, the coordinate of display position of the respective entire comments is calculated at every predetermined time, and it is determined whether there is overlap based on the calculated values. Note that the determination of overlaps among the entire comment and the partial comment can be executed by the coordinates of vertical display positions of both comments and display time of the partial comment. When there is overlap, the number of overlaps is counted. When any overlap is not allowed, the counting of the number of overlaps is not executed, and only the determination is executed.

When it is determined that the number of overlaps is more than or equal to the predetermined number (or there is overlap of comments), as to other comments excluding a comment, one or more of the duration of the moving display, the speed of the moving display of the entire comment to be displayed, the position of the entire comment in the basic display unit of the content, and the character size of the comment is varied (step S1402). Specifically, as to other comments excluding one comment, for example, the processing of varying the starting time, and the moving speed, and the character size is executed in addition to variation of the starting position, and it is repeatedly determined whether there are overlaps among the entire comments displayed on the basis of the tentative parameter. Note that, as to the processing of varying the starting time, and the moving speed, and the character size, as described above, the variation may be executed according to the priority determined by ascending/descending time order of comment placing time indicated by the additional information of the comment, and a priority determined by the valuation cumulative total value etc.

Subsequently, the processing is repeated until the number of overlaps determined by the step S1401 is less than or equal to the predetermined number. The parameter at the point, where the number of overlaps is less than or equal to the predetermined number among the entire comments, is finally determined as the final parameter.

### Effects of Third Embodiment

According to the content viewing apparatus of the third embodiment, it is possible to display a plurality of entire comments without overlap, or the moving comment without overlapping with the partial comment, which is fixedly displayed. Therefore, the user can easily understand the respective comments.

Description of Reference Numerals

0200 Content viewing apparatus

0201 Display

0202 Content acquisition unit

0203 Comment acquisition unit

0204 Output unit

0205 Determination unit

0206 Entire comment display controller

0207 Partial comment display controller

What is claimed is:

1. A content viewing apparatus, comprising:
a display;
a content acquisition unit, acquiring a content that can be correlated with an entire comment placed to a basic display unit for displaying the content on the display, and with a partial comment placed to a portion within the basic display unit for displaying the content on the display;
a comment acquisition unit, acquiring the comment;
an output unit, outputting the acquired content, to which the comment correlated with the content is added, to the display;
a determination unit, determining whether the content, outputted from the output unit and to be displayed on the display, has been correlated with the entire comment and/or the partial comment;
an entire comment display controller, when the determination result by the determination unit indicates that the entire comment is correlated, controlling the output unit to display the correlated entire comment by moving display within the display; and
a partial comment display controller, when the determination result by the determination unit indicates that the partial comment is correlated, controlling the output unit to fixedly display the correlated comment in a predetermined area within the display.

2. The content viewing apparatus according to claim 1,
wherein the comment acquisition unit acquires the entire comment to be displayed by the moving display, the entire comment is correlated with a portion in the basic display unit in the content.

3. The content viewing apparatus according to claim 2, further comprising:
a scaling display controller, controlling to display the basic display unit of the content on the display by enlarging and/or reducing,
wherein the entire comment display controller controls the moving display of the entire comment in the content displayed by the enlarging and/or reducing on a basis of the portion in the basic display unit of the content correlated with the acquired entire comment

4. The content viewing apparatus according to claim 1,
wherein the entire comment display controller determines one or more of a duration of the moving display, a speed of the moving display of the entire comment to be displayed, a position of the entire comment in the basic display unit of the content, and a character size of the comment.

5. A comment distribution server, distributing a comment correlated with a content that can be correlated with an entire comment placed to a basic display unit for displaying the content on a display of a terminal apparatus, and with a partial comment placed to a portion within the basic display unit for displaying the content on the display of the terminal apparatus, the server comprising:
an entire comment distribution unit, when the entire comment is correlated with the content displayed on the display of the terminal apparatus, distributing the entire comment displayed by moving display within the display; and
a partial comment distribution unit, when the partial comment is correlated with the content displayed on the display of the terminal apparatus, distributing the partial comment fixedly displayed in a predetermined area within the display.

6. A method for operating a content viewing apparatus that comprises a display, the method causing a computer to execute a process, comprising:
acquiring a content that can be correlated with an entire comment placed to a basic display unit for displaying the content on the display, and with a partial comment placed to a portion within the basic display unit for displaying the content on the display;
acquiring the comment;
controlling output of the acquired content, to which the comment correlated with the content is added, to the display;
determining whether the content, outputted from the output unit and to be displayed on the display, has been correlated with the entire comment and/or the partial comment;
when the determination result by the determination unit indicates that the entire comment is correlated, displaying the correlated entire comment by moving display within the display; and
when the determination result by the determination unit indicates that the partial comment is correlated, fixedly displaying the correlated comment in a predetermined area within the display.

7. A computer-readable storage medium storing a program for causing a computer to execute a process of operating a content viewing apparatus that comprises a display, the program comprising:
acquiring a content that can be correlated with an entire comment placed to a basic display unit for displaying the content on the display, and with a partial comment placed to a portion within the basic display unit for displaying the content on the display;
acquiring the comment;
controlling output of the acquired content, to which the comment correlated with the content is added, to the display;
determining whether the content, outputted from the output unit and to be displayed on the display, has been correlated with the entire comment and/or the partial comment;
when the determination result by the determination unit indicates that the entire comment is correlated, displaying the correlated entire comment by moving display within the display; and
when the determination result by the determination unit indicates that the partial comment is correlated, fixedly displaying the correlated comment in a predetermined area within the display.
